(19) United States
(12) Patent Application Publication
(10) Pub. No.: US 2016/0351917 A1
(43) Pub. Date: Dec. 1, 2016

(54) MATERIALS, DEVICES AND METHODS RELATED TO SOLID OXIDE FUEL CELLS

(71) Applicant: SKYWORKS SOLUTIONS, INC., Woburn, MA (US)

(72) Inventors: Michael David HILL, Frederick, MD (US); Jeffrey Alan SHUNKWILER, Frederick, MD (US)

(21) Appl. No.: 15/168,558

(22) Filed: May 31, 2016

Related U.S. Application Data
(60) Provisional application No. 62/168,879, filed on May 31, 2015.

(51) Int. Cl. H01M 4/90; H01M 8/1253; H01M 8/126; H01M 8/2425

(52) U.S. Cl. CPC H01M 4/9033; H01M 8/2425; H01M 8/1253; H01M 8/126; H01M 2008/1293

(57) ABSTRACT

Materials, device and methods related to solid oxide fuel cells (SOFCs). In some embodiments, a solid oxide fuel cell (SOFC) can include an electrochemically active component having a multiphase ceramic with a stabilized metal oxide material and a magnetoplumbite-based material. The multiphase ceramic can be configured to provide enhanced fracture toughness for the electrochemically active component. The stabilized metal oxide material can include cerium oxide, and the electrochemically active component can include an anode. One or more of such SOFC can be configured as a power source device.

### CROSS-REFERENCE TO RELATED APPLICATION(S)

This application claims priority to U.S. Provisional Application No. 62/168,879 filed May 31, 2015, entitled CERIUM OXIDE MATERIALS HAVING IMPROVED MECHANICAL PROPERTIES, the disclosure of which is hereby expressly incorporated by reference herein in its entirety.

### BACKGROUND

Field

The present disclosure relates to materials, devices and methods associated with solid oxide fuel cells.

Description of the Related Art

A solid oxide fuel cell (SOFC) is a device that generates electricity from an electrochemical conversion involving oxidation of fuel. Such a device can have desirable properties such as high efficiency and low emission when operated at high temperatures.

### SUMMARY

According to a number of implementations, the present disclosure relates to a solid oxide fuel cell (SOFC) having an electrochemically active component that includes a multiphase ceramic having a stabilized metal oxide material and a magnetoplumbite-based material. The multiphase ceramic is configured to provide enhanced fracture toughness for the electrochemically active component.

In some embodiments, the stabilized metal oxide material can include at least one of stabilized cerium oxide and stabilized zirconium oxide. The electrochemically active component can include an anode, and such an anode can include the stabilized cerium oxide.

In some embodiments, the electrochemically active component can include an electrolyte. Such an electrolyte can include the stabilized zirconium oxide.

In some embodiments, the stabilized metal oxide material can be configured to provide a first phase of the multiphase ceramic. The magnetoplumbite-based material can be configured to provide a second phase of the multiphase ceramic that is chemically compatible with the first phase. The stabilized metal oxide material can include stabilized cerium oxide. The magnetoplumbite-based material can include an aluminate. The stabilized metal oxide material can include a stabilizing element selected from the group consisting of Mg, Ca, La, In, Sc, Ce, Pr, Nd, Sm, Gd, Dy, Tb, Eu, Ho, Er, Yb, Y, Lu, Tm, Ga, Fe, Mn, Cr, and Bi. The stabilized cerium oxide can include Gd_{0.2}Ce_{0.8}Oₓ.

In some embodiments, the aluminate can include one or more of LaAl₁₁O₁₈, PrAl₁₁O₁₈ and NdAl₁₁O₁₈.

In some embodiments, the aluminate can include LaAl₁₁O₁₈. Such an aluminate can form 40% or more in specific weight percentage relative to the stabilized cerium oxide.

In some embodiments, the aluminate can include PrAl₁₁O₁₈. Such an aluminate can form 20% or more in specific weight percentage relative to the stabilized cerium oxide.

In some embodiments, the aluminate can include NdAl₁₁O₁₈. Such an aluminate can form 60% or more in specific weight percentage relative to the stabilized cerium oxide.

In some embodiments, the enhanced fracture toughness of the multiphase ceramic can be sufficient such that the electrochemically active component provides structural support for the SOFC. The electrochemically active component can include an anode configured to provide the structural support for the SOFC.

In some implementations, the present disclosure relates to a solid oxide fuel cell (SOFC) based device having a plurality of SOFCs electrically connected to be capable of generating an output voltage. Each SOFC includes an electrochemically active component having a multiphase ceramic with a stabilized metal oxide material and a magnetoplumbite-based material. The multiphase ceramic is configured to provide enhanced fracture toughness for the electrochemically active component.

In some embodiments, the plurality of SOFCs can be electrically connected in series. In some embodiments, the plurality of SOFCs can be arranged in a stack configuration.

In some embodiments, the electrochemically active component can include an anode. At least some of the anodes can be configured such that the enhanced fracture toughness of the multiphase ceramic is sufficient such that the anodes provide structural support for the SOFC based device. In some embodiments, the stabilized metal oxide can include stabilized cerium oxide.

In some teachings, the present disclosure relates to a power source device having one or more solid oxide fuel cells (SOFCs) configured to generate electrical power when operating. Each SOFC includes an electrochemically active component having a multiphase ceramic with a stabilized metal oxide material and a magnetoplumbite-based material. The multiphase ceramic is configured to provide enhanced fracture toughness for the electrochemically active component.

In some embodiments, the electrochemically active component can include an anode. In some embodiments, the stabilized metal oxide can include stabilized cerium oxide.

According to some teachings, the present disclosure relates to a method for fabricating an electrochemically active component for a solid oxide fuel cell (SOFC). The method includes providing a stabilized metal oxide material, and combining a magnetoplumbite-based material with the stabilized metal oxide to form a mixture. The method further includes firing the mixture to form a multiphase ceramic capable of being formed into the electrochemically active component.

In some embodiments, the method can further include forming the electrochemically active component with the multiphase ceramic. The electrochemically active component can include an anode, and the stabilized metal oxide material can include stabilized cerium oxide.

In accordance with a number of implementations, the present disclosure relates to a method for fabricating a solid oxide fuel cell (SOFC). The method includes forming or providing a multiphase ceramic that includes a fired mixture of a magnetoplumbite-based material and a stabilized metal oxide material. The method further includes forming an electrochemically active component with the multiphase ceramic. The method further includes assembling the multiphase ceramic electrochemically active component with one or more other components to form the SOFC.

In some embodiments, the electrochemically active component can include an anode, and the stabilized metal oxide material can include stabilized cerium oxide. The one or more other components can include an electrolyte and a cathode.

In some implementations, the present disclosure relates to a method for fabricating a solid oxide fuel cell (SOFC) based power source. The method includes forming or providing a plurality of SOFCs, with each SOFC including an electrochemically active component having multiphase ceramic with a stabilized metal oxide material and a magnetoplumbite-based material. The multiphase ceramic electrochemically active component has enhanced fracture toughness. The method further includes electrically connecting the plurality of SOFCs such that the connected SOFCs are capable of generating a desired output voltage when operating.

In some embodiments, the electrochemically active component can include an anode. The stabilized metal oxide material can include stabilized cerium oxide.

For purposes of summarizing the disclosure, certain aspects, advantages and novel features of the inventions have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 shows an example solid oxide fuel cell (SOFC) having an electrolyte implemented between an anode and a cathode.

FIG. 2 shows that in some embodiments, an SOFC having one or more features as described herein can be implemented in a planar configuration.

FIGS. 3A and 3B show that in some embodiments, an SOFC having one or more features as described herein can be implemented in a tubular configuration.

FIG. 4 shows that in some embodiments, an anode of an SOFC can include cerium oxide material with enhanced toughness.

FIGS. 5A and 5B are schematic illustrations of a transformation toughening mechanism.

FIGS. 6A and 6B are schematic illustrations of a ferroelastic toughening mechanism.

FIGS. 7A and 7B are schematic illustrations of a crack bridging toughening mechanism.

FIG. 8 is a phase diagram for the ternary ZrO₂—Nd₂O₃—Al₂O₃ system at about 1250° C.

FIG. 9 is a schematic illustration of the microstructure of a two-phase ceramic of an embodiment illustrating the stabilized metal oxide matrix and magnetoplumbite second phase.

FIGS. 10A-10C show that in some embodiments, an anode of an SOFC can include a multiphase ceramic material.

FIG. 11 shows a process that can be implemented to fabricate a multiphase ceramic material having one or more features as described herein.

FIG. 12 shows a process that can be implemented to fabricate an SOFC.

FIG. 13 shows that in some embodiments, a plurality of SOFCs having one or more features as described herein can be arranged in a stack configuration.

FIG. 14 shows an example of an electrical power source having a stack having one or more features as described herein.

### DETAILED DESCRIPTION OF SOME EMBODIMENTS

The headings provided herein, if any, are for convenience only and do not necessarily affect the scope or meaning of the claimed invention.

Described herein are various examples related to cerium oxide materials having improved mechanical properties. Such improved mechanical properties can allow cerium oxide materials to be utilized in, for example, solid oxide fuel cell (SOFC) applications. Although various examples are described in the context of such SOFC applications, it will be understood that one or more features of the present disclosure can also be implemented in other applications. Such other applications can include, for example, applications in which a combination of electrochemical performance and mechanical toughness of ceramic materials is desired.

An SOFC is a device that generates electricity from an electrochemical conversion involving oxidation of fuel. Such a device can have desirable properties such as high efficiency and low emission when operated at high temperatures. Aside from such properties, robust mechanical properties of ceramics used in SOFC devices, such as anode or electrolyte supported SOFC devices, are also desirable. Zirconia based materials are utilized in some SOFC devices to provide adequate mechanical properties for long service lifetimes at elevated temperatures (e.g., about 600 to 1000 degree C.).

As improved electrochemical performance (e.g., to provide higher power densities) is desired, cerium oxide based materials can be utilized in ceramic components, such as anodes, of SOFC devices. Conventional cerium oxide anode structures, however, typically suffer from much lower fracture toughness than the foregoing zirconia based anodes.

Described herein are various examples related to use of cerium oxide based materials in SOFC components such as anodes to provide improved mechanical properties (such as higher fracture toughness) while also providing sufficient or high electrochemical properties. Although various examples are described in the context of SOFC anodes, it will be understood that one or more features of the present disclosure can also be utilized for other components of SOFC devices.

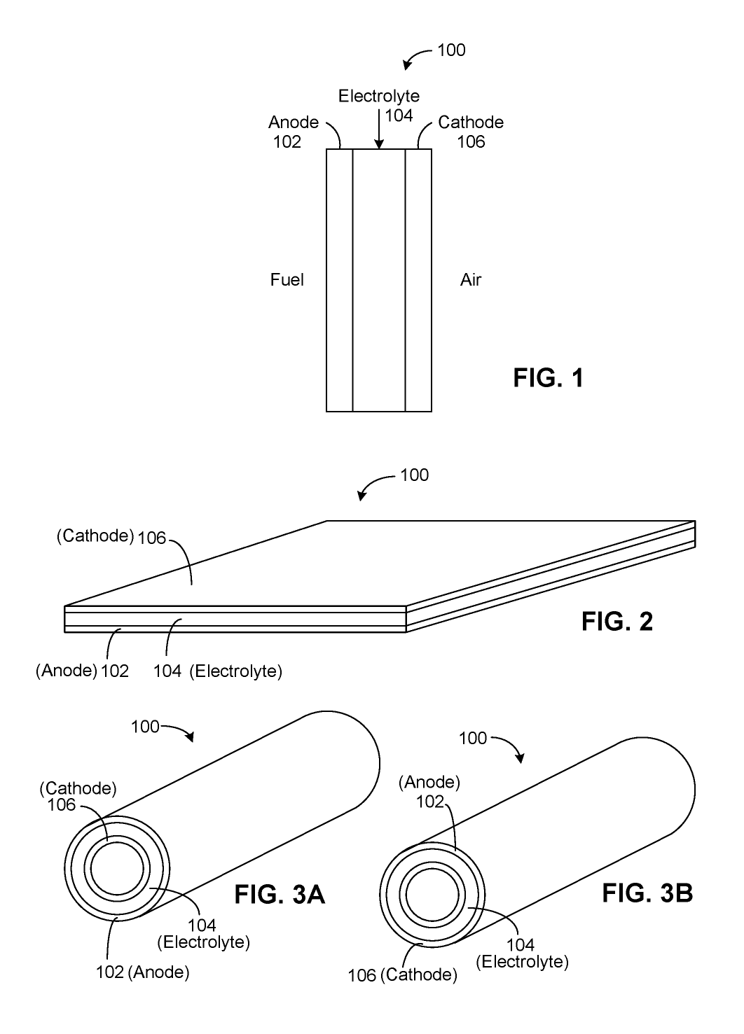

FIG. 1 shows an example SOFC 100 having an electrolyte 104 implemented between an anode 102 and a cathode 106. As is generally understood, fuel is typically introduced on the anode side, and air is typically introduced on the cathode side. When operated at high temperatures, such a configuration results in an electrical current flowing between the anode 102 and the cathode 106 (assuming presence of an electrical load). Accordingly, the SOFC 100 can function as a power source. In some embodiments, the anode 102 of the SOFC 100 can include one or more features as described herein.

FIGS. 2 and 3 show that SOFCs having one or more features as described herein can be implemented in different form factors. For example, FIG. 2 shows that an SOFC 100 can be implemented in a planar configuration. In such a configuration, each of an anode 102, an electrolyte 104, and a cathode 106 can be in a planar layer such that the SOFC 100 itself has a generally planar form.

In another example, FIGS. 3A and 3B show that an SOFC 100 can be implemented in a tubular configuration. In such a configuration, an anode 102, an electrolyte 104, and a cathode 106 can be arranged in a co-axial assembly such that the SOFC 100 itself has a generally tubular form. In the example of FIG. 3A, the anode 102 is on the outside, and the cathode 106 is on the inside. In the example of FIG. 3B, the cathode 106 is on the outside, and the anode 102 is on the inside.

It will be understood that an SOFC having one or more features as described herein can be implemented in other form factors.

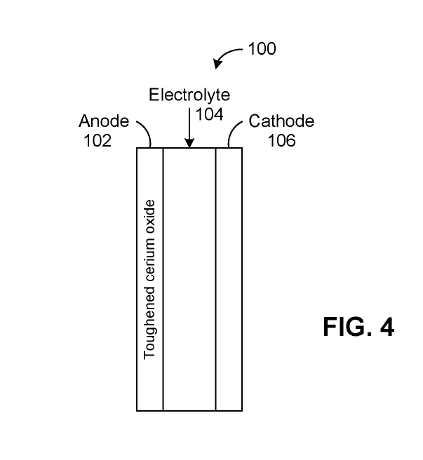

FIG. 4 shows that in some embodiments, an anode 102 of an SOFC 100 can include cerium oxide material with enhanced toughness. The SOFC 100 is shown to further include an electrolyte 104 and a cathode 106. As described herein, such an anode 102 can have mechanical properties such as enhanced fracture toughness. Examples of how such enhancement in fracture toughness can be achieved are described herein in greater detail.

Examples Related to Materials with Enhanced Toughness:

In general, resistance to impact and erosion resistance in ceramics may be improved by introducing toughening mechanisms which raise the ceramic's resistance to crack propagation (e.g., fracture toughness (K), toughness (G)). Embodiments of the present disclosure can provide a two-phase ceramic which includes a plurality of toughening mechanisms at use temperatures of interest (e.g., approximately 1100° C. and higher) and exhibits improved toughness, while retaining its thermal insulating properties.

The first phase of the ceramic, in the as-deposited state, can include a metal oxide which exhibits a stable cubic fluorite phase (c), a stable tetragonal phase (t), or a metastable tetragonal phase (t′). Examples may include, but are not limited to, stabilized zirconium oxide (zirconia, ZrO₂) and stabilized hafnium oxide (HfO₂). In the discussion herein, embodiments of the ceramic composition may be discussed in terms of zirconium oxide. However, it may be understood the disclosed embodiments are not limited only to zirconia but may also include other metal oxides (e.g., hafnia).

As discussed in greater detail herein, in some embodiments, the first phase of the ceramic may provide transformation toughening. In this process, the tetragonal phase ahead of a crack under an applied external stress can convert to the higher volume monoclinic phase, arresting crack development. In alternative embodiments, the tetragonal phase ahead of a crack under an applied external stress may be non-transforming and instead rotates to align with the direction of the applied external stress, also arresting crack development. This is commonly referred to as ferroelastic toughening.

The second phase of the ceramic, in the as-deposited state, can include a compound chemically compatible with the stabilized metal oxide first phase. For example, no substantial chemical reaction takes place between the first and second phases. Furthermore, the second phase can possess low symmetry and anisotropic growth habit. In some embodiments, the second phase can include a magnetoplumbite-based aluminate phase. As discussed herein, this second phase can arrest crack development by the mechanism of crack bridging.

A brief discussion of transformation toughening, ferroelastic toughening, and crack bridging will now be presented.

Pure ZrO₂ can undergo crystallographic phase changes, from the monoclinic phase (m) to the tetragonal phase (t), to the cubic phase (c) with increasing temperature. The volume of zirconia can concurrently decrease when transforming from the m to t to c phase. However, addition of one or more stabilizing agents (e.g., oxides) may stabilize the t-phase in zirconia and inhibit the temperature-dependent phase transformation. In some embodiments, the tetragonal phase may be meta-stable, denoted by t′. However, it may be understood that reference to tetragonal phases herein may include both stable and meta-stable tetragonal phases.

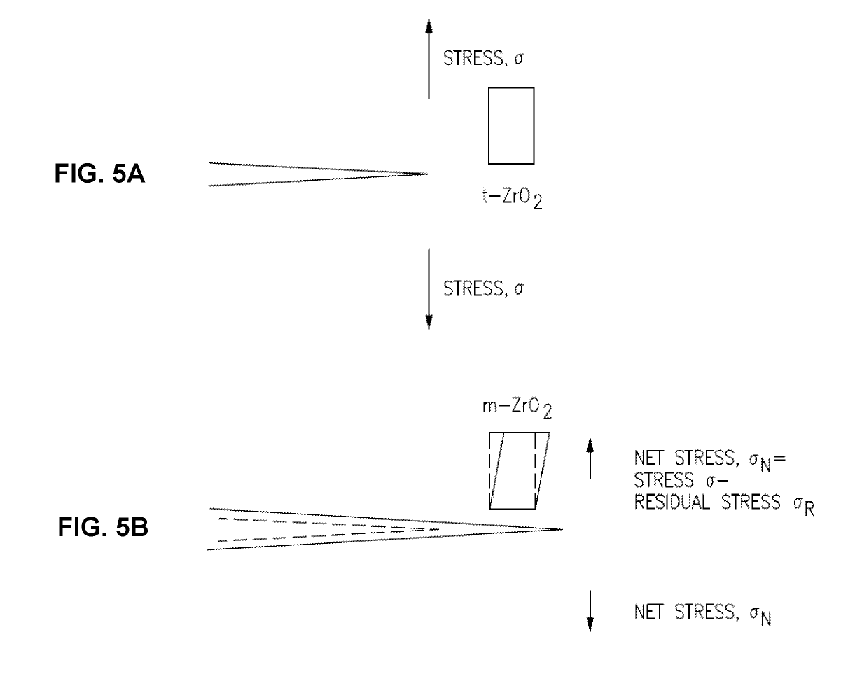

In transformation toughened zirconia, the stabilizing agent can be provided in an amount such that the t-phase is meta-stable with temperature. For example, the t-ZrO₂ phase does not exhibit the transformation to another phase with temperature observed in pure zirconia. Instead, when a crack is initiated in the stabilized zirconia, as illustrated in FIG. 5A, some t-phase zirconia in the region of elevated stress ahead of the crack tip may be transformed to the m-phase. The volume expansion accompanying the t-ZrO₂ to m-ZrO₂ phase transformation can result in development of residual compressive stresses in the zirconia about the m-ZrO₂ which can reduce the net effect of the remote stress, as illustrated in FIG. 5B. Thus, absent an increase in the remotely applied stress, crack propagation can be arrested due to the phase transformation of t-ZrO₂ to m-ZrO₂, toughening the ceramic.

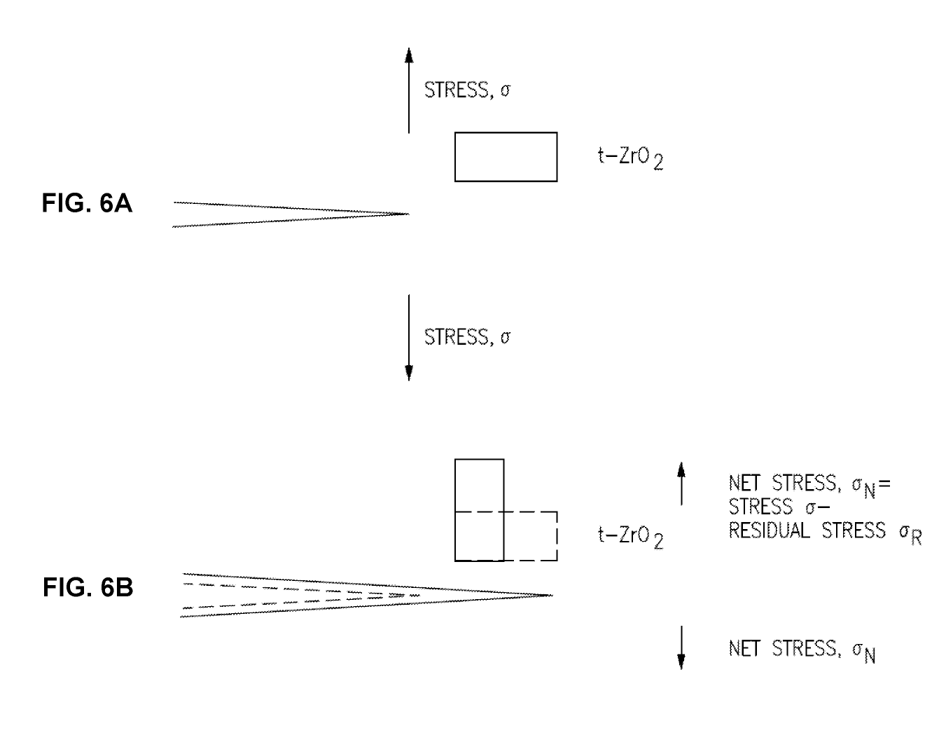

In ferroelastic toughening, a ceramic capable of forming a metastable tetragonal phase (e.g., zirconia, hafnia) can be employed. One or more stabilizing agents can be provided in respective amounts such that the t-phase does not transform to the m-phase on cooling. However, this t-phase can be distinguished from that observed in transformation toughening, as it does not transform to the m-phase when exposed to elevated stress either. With reference to FIGS. 6A and 6B, a crack is illustrated in a stabilized zirconia, where a region of the t-phase is present ahead of the crack tip. When the crack propagates under the influence of a remotely applied stress, some of the t-phase zirconia in the region of elevated stress ahead of the crack tip can rotate to become aligned in the direction of the remotely applied stress. In some situations, such an alignment can include an axis of the t-phase zirconia having a direction component common with a direction component of the remotely applied stress. This switching can cause residual stresses to develop in the zirconia about the switched t-ZrO₂ which reduces the net effect of the remote stress, as illustrated in FIG. 6B. As a result, further crack growth can be inhibited. In some situations, such a stoppage of crack growth can be realized if there is no significant increase in the remotely applied stress.

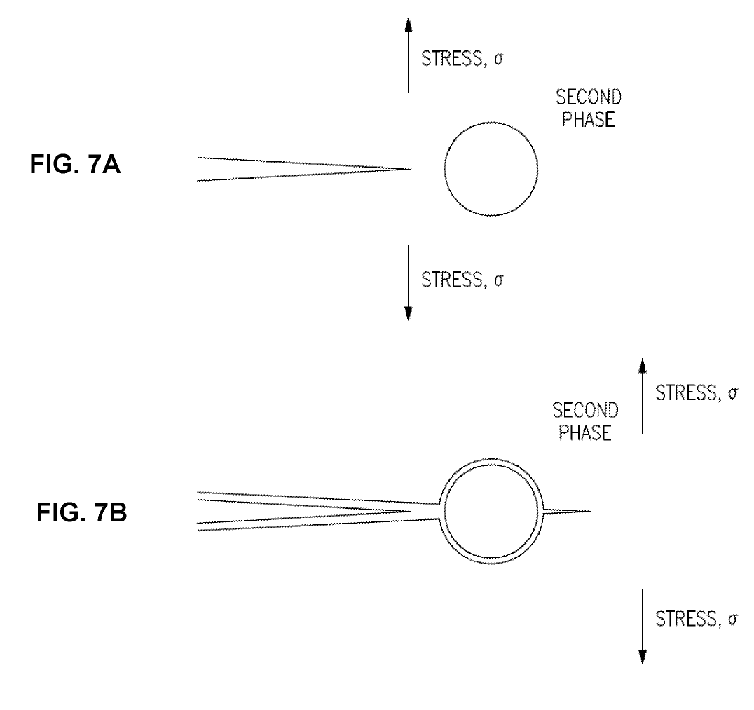

With reference to FIGS. 7A and 7B, in crack bridging, a second phase material can be dispersed within a first phase material. When the crack propagates under the influence of a remotely applied stress, it can impinge upon the second phase. Assuming that the second phase does not fracture, further growth of the crack can be achieved by deflection of the crack around the periphery of the second phase. The second phase can toughen the ceramic in two ways. First, in order for the crack to deflect about the second phase, debonding can occur between the second phase and the first phase. Accordingly, debonding typically requires that the applied stress be increased, which elevates the toughness of the two-phase ceramic. As the crack further propagates and opens, frictional sliding can take place between the surface of the second phase and the adjacent edges of the crack. The applied stress can also be increased to overcome the frictional sliding resistance between the crack and the second phase, further elevating the toughness of the two-phase ceramic.

In some embodiments, formation of the second phase can involve at least a ternary (three-component) system of the metal oxide, an oxide stabilizing the t-phase of the metal oxide, and an oxide of the magnetoplumbite former. As discussed in greater detail herein, more complex magnetoplumbites may also be formed from higher order systems (e.g., quaternary, or four components, five components, six components, seven components, etc.).

In an embodiment, the first phase of the ceramic may include a metal oxide which exhibits a cubic, tetragonal, or a meta-stable tetragonal phase after deposition on a substrate. For example, the metal oxide may be a stabilized metal oxide, in which one or more stabilizing elements are substituted for the zirconium atoms in ZrO₂. Examples of single stabilizing elements may be selected from, but are not limited to, Mg, Ca, Sc, Y, In, Ga, and lanthanides (e.g., La, Ce, Pr, Nd, Sm, Eu, Gd, Tb, Dy, Ho, Er, Tm, and Yb). In alternative embodiments, the zirconia may be co-stabilized with two elements, a first element selected from one of Mg, Ca, Sc, Y, In, Ga, and lanthanides (e.g., La, Ce, Pr, Nd, Sm, Eu, Gd, Tb, Dy, Ho, Er, Lu, Tm, and Yb) and a second element selected from Nb and Ta. The second phase may include aluminates with the magnetoplumbite structure.

In some embodiments, the ceramic composition may be formed from a ternary (three-component) system given by Ln₂O₃—(Zr,Hf)O₂—Al₂O₃. For clarity in the discussion herein, reference will be made to zirconia. However, it may be understood that embodiments of the disclosure may alternatively employ hafnia or another metal oxide capable of forming a stabilized tetragonal phase.

The addition of Ln₂O₃ and Al₂O₃ to the ceramic can promote formation of a second phase magnetoplum bite-based aluminate formed from Ln₂O₃—Al₂O₃ that is chemically compatible with a first tetragonal zirconia stabilized by Ln. In one embodiment, the magnetoplumbite-based aluminate can have the form LnAl₁₁O₁₈. Ln may be selected from lanthanides, including, but not limited to, La, Pr, Nd, and Sm. Notably, in embodiments of the ternary system, the same lanthanide, Ln, can be used to stabilize the zirconia and form a second phase magnetoplumbite-based aluminate compatible with the stabilized zirconia of that particular lanthanide.

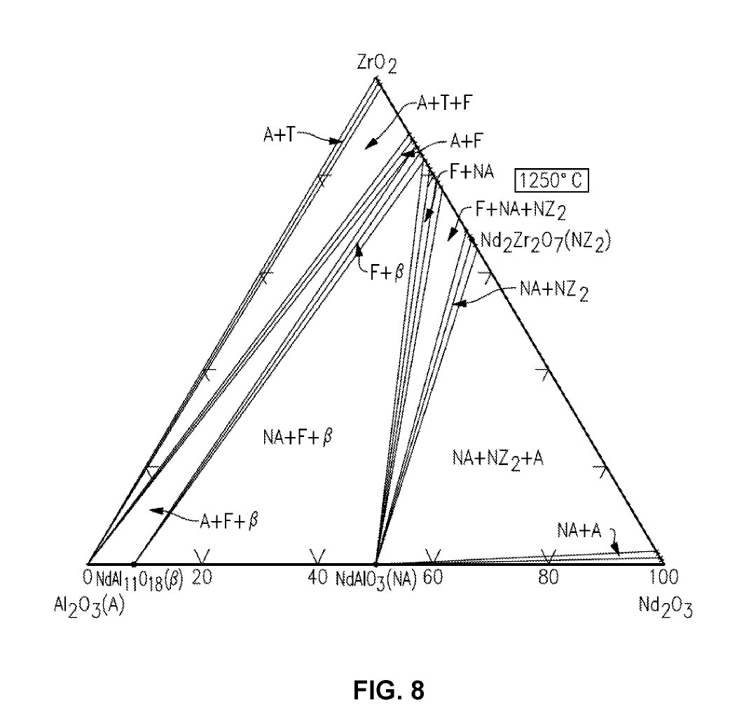

For example, assume that Ln is Nd. The ternary phase diagram for Nd₂O₃—ZrO₂—Al₂O₃ at 1250° C. is illustrated in FIG. 8. In the phase diagram, A denotes the corundum phase of alumina, T denotes tetragonal ZrO₂, F denotes fluorite (cubic zirconia), NZ₂ denotes a pyrochlore-type phase, NA denotes a perovskite-type phase, and β denotes the magnetoplumbite-based aluminate, NdAl₁₁O₁₈.

The compositions of interest in this ternary system for use in generating the two-phase ceramic can include those given by the stable, two-phase field labeled F+β. This phase field extends between the vertices given by:
about 10 mol. % Nd₂O₃—about 90 mol. % Al₂O₃—about 0 mol. % ZrO₂ (NdAl₁₁O₁₈) on the Al₂O₃—Nd₂O₃ axis (bottom of FIG. 8) to
about 14 mol. % Nd₂O₃—about 0 mol. % Al₂O₃—about 86 mol. % ZrO₂ on the ZrO₂—Nd₂O₃ axis (right side of FIG. 8) to
about 17 mol. % Nd₂O₃—about 0 mol. % Al₂O₃—about 83 mol. % ZrO₂ on the ZrO₂—Nd₂O₃ axis (right side of FIG. 8).
   In this phase field, the second phase magnetoplumbite-based aluminate, NdAl₁₁O₁₈, can be present. Thus, it is expected that toughening due to crack bridging will take place in the ceramic. Stabilized ZrO₂ (ZrO₂—Nd₂O₃) may form the tetragonal or cubic phase zirconia on deposition of the composition and cooling. Accordingly, it is also expected that toughening due to at least one of transformation toughening and ferroelastic toughening will take place, depending on whether the tetragonal zirconia undergoes phase transformation under stress or is non-transforming and aligns with the external field under stress.

Although the phase diagram for FIG. 8 is isothermal, representing the phase states of the ternary Nd₂O₃—ZrO₂—Al₂O₃ system at 1250° C., it is expected that the desired F+β phase field will also persist at temperatures higher and lower than 1250° C. Notably, however, the shape of the F+β phase field may change with temperature. For example, it is expected that, as the temperature increases, the upper limit of ZrO₂ in the F phase (e.g., the intersection of the top leg of the phase field with the ZrO₂—Nd₂O₃ axis) will move towards greater ZrO₂ (upwards). Furthermore, it is expected that, as the temperature decreases, the lower limit of the ZrO₂ in the F phase (e.g., the intersection of the bottom leg of the phase field with the ZrO₂—Nd₂O₃ axis) will move towards greater Nd₂O₃ (downwards).

In alternative embodiments, the ceramic composition may be formed from a quaternary (four component) system given by, for example, Ln₂O₃-Ln′₂O₃—ZrO₂—Al₂O₃. The two-phase ceramic formed from this system may include a second phase magnetoplumbite-based aluminate formed from Ln₂O₃ and Al₂O₃ that is chemically compatible with a first, tetragonal zirconia phase stabilized by Ln′. This quaternary system can be in contrast to the ternary system discussed herein, where Ln is employed both for forming the magnetoplumbite, as well as stabilizing the zirconia. In some embodiments, Ln can be a magnetoplumbite former with aluminum oxide and may be selected from lanthanides including, but not limited to, La, Pr, Nd, and Sm. In further embodiments, Ln′ can be a trivalent stabilizer of zirconia different than Ln and may be selected from lanthanides (e.g., La, Ce, Pr, Nd, Sm, Eu, Gd, Tb, Dy, Ho, Er, Tm, and Yb) as well as Sc, Y, Lu, Ga, Fe, Mn, Cr, In, and Bi. The amount of the magnetoplumbite formed, in certain embodiments, may be between about 10 mol. % and less than about 50 mol. %.

In an embodiment, the ceramic composition may be formed from a five component system given by, for example, MOₓ-Ln₂O₃-Ln′₂O₃—ZrO₂—Al₂O₃, where MOₓ can be a metal magnetoplumbite former with aluminum oxide and Ln and Ln′ can be as described herein. The addition of the MOₓ metal oxide to the ceramic can promote formation of a two-phase ceramic including a more complex magnetoplumbite-based aluminate second phase formed from MOₓ, Ln₂O₃, and Al₂O₃ that is chemically compatible with a first, tetragonal zirconia phase stabilized by Ln′. In some embodiments, M can be selected from Na, K, Mg, Li, Ca, Sr, and Ba. Ln can be a magnetoplumbite former with aluminum oxide and may be selected from lanthanides including, but not limited to, La, Pr, Nd, and Sm. In further embodiments, Ln′ can be different from Ln and may be selected from lanthanides (e.g., La, Ce, Pr, Nd, Sm, Eu, Gd, Tb, Dy, Ho, Er, Tm, and Yb), as well as Sc, Y, Lu, In, Ga, Fe, Mn, Cr, and Bi. The amount of the magnetoplumbite formed, in some embodiments, may be between about 10 mol. % and less than about 50 mol. %.

In other embodiments, the ceramic composition may be formed from five component system given by, for example, Ln₂O₃-Ln′₂O₃-M′O—ZrO₂—Al₂O₃ or Ln₂O₃-Ln′₂O₃-M″O—ZrO₂—Al₂O₃. In these embodiments, the M′O or M″O can be employed in conjunction with Ln′ as a co-stabilizer for ZrO₂. The two-phase ceramic formed from this system can include a magnetoplumbite-based aluminate second phase formed from Ln₂O₃ and Al₂O₃ that is chemically compatible with a first, tetragonal zirconia phase co-stabilized by both M′ and Ln′ or M″ and Ln′. In some embodiments, M′O can be a divalent co-stabilizer of zirconia. For example, M′ may be selected from Mg and Ca. In other embodiments, M″O can be a pentavalent co-stabilizer of zirconia. For example, M″ may be selected from Nb, Ta, and Sb. Ln can be a magnetoplumbite former with aluminum oxide and may be selected from lanthanides including, but not limited to, La, Pr, Nd, and Sm. In further embodiments, Ln′ can be a trivalent stabilizer of zirconia different than Ln and may be selected from lanthanides (e.g., La, Ce, Pr, Nd, Sm, Eu, Gd, Tb, Dy, Ho, Er, Tm, and Yb), as well as Sc, Y, Lu, In, Ga, Fe, Mn, Cr, and Bi). The amount of the magnetoplumbite formed, in some embodiments, may be between about 10 mol. % and less than about 50 mol. %.

In an embodiment, the ceramic composition may be formed from a six component system given by, for example, MOₓ-Ln₂O₃-Ln′₂O₃-M′O—ZrO₂—Al₂O₃ or MOₓ-Ln₂O₃-Ln′₂O₃-M″O—ZrO₂—Al₂O₃, where both MOₓ and M′O or MOₓ and M″O can be included in the composition, as discussed herein. The addition of the MOₓ metal oxide to the ceramic can promote formation a two-phase ceramic including a complex magnetoplumbite second phase formed from MOₓ, Ln₂O₃, and Al₂O₃ that is chemically compatible with a first, tetragonal zirconia phase co-stabilized by Ln′ and either M′O or M″O. M, M′, M″, Ln, and Ln′ can be as described herein. The amount of the magnetoplumbite formed, in some embodiments, may be between about 10 mol. % and less than about 50 mol. %.

In an embodiment, the ceramic composition may be formed from a seven component system given by, for example, MOₓ-Ln₂O₃-Ln′₂O₃-M″O-AO—ZrO₂—Al₂O₃, where AO, a divalent stabilizer of zirconia, can be added to a six component composition as described herein. The two-phase ceramic formed from this system can include a complex magnetoplumbite-based aluminate formed from MOₓ-Ln₂O₃—Al₂O₃ that is chemically compatible with a first, tetragonal zirconia phase stabilized by Ln′ (trivalent zirconia stabilizer), M″O (pentavalent zirconia stabilizer), and AO (divalent zirconia stabilizer). M, M′, M″, Ln, Ln′ can be as described herein and AO can be selected from divalent stabilizers of aluminum. A may be selected from Mg and Ca. The amount of the magnetoplumbite formed, in some embodiments, may be between about 10 mol. % and less than about 50 mol. %.

The example ceramic compositions described herein may be prepared for deposition on a substrate. For example, in one embodiment, a composition having one or more features as described herein may be prepared as a powder, suitable for spray deposition (e.g., plasma spray, high velocity oxygen fuel). In alternative embodiments, the composition may be prepared as an ingot suitable for vapor deposition (e.g., electron-beam physical vapor deposition (EB-PVD), electrostatic spray assisted vapor deposition (ESAVD), direct vapor deposition, etc.). The manner of preparing and depositing thermal barrier coating compositions are generally understood in the art and not discussed in detail herein.

In some embodiments, one or more of the ceramic compositions described herein may be prepared for formation of components of, for example, SOFC devices. As described herein, such components can include electrodes such as anodes. For example, in one embodiment, a composition having one or more features as described herein may be prepared as a powder, and such a powder can be formed into a desired shaped object. In some embodiments, such a formed shape can be sintered to provide a desired form of a component for the SOFC.

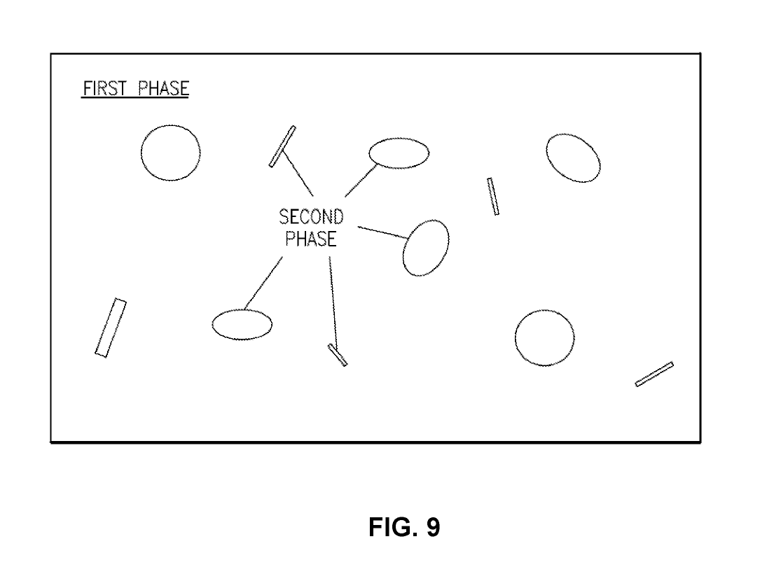

FIG. 9 illustrates a schematic example of an anticipated microstructure of a two-phase ceramic composition as discussed herein, after formation and cooling. For example, first phase of zirconia, at least a portion of which includes tetragonally stabilized zirconia, can surround a plurality of magnetoplumbite-based aluminate second phase particles. The second phase may be distributed throughout the first phase and may be oriented at a plurality of angles.

In order to illustrate the feasibility of obtaining crack bridging and, optionally, transformation or ferroelastic toughening, in embodiments of the disclosed ceramic compositions, the phases present in these compositions were characterized using X-ray diffraction (XRD). As illustrated in Table 1 below, 14 ceramic compositions were investigated at temperatures at about 1450° C., about 1500° C., and about 1600° C. As discussed above, in order to achieve toughening by crack bridging, the magnetoplumbite phase is typically present in the ceramic. Furthermore, in order to achieve either transformation toughening or ferroelastic toughening, tetragonal zirconia ((t) ZrO₂) is typically present in the ceramic.

TABLE 1

| | Composition | Phases after | Phases after | Phases after |
|---|---|---|---|---|
| Sample | (weight %) | 1450° C. | 1500° C. | 1600° C. |
| 1 | 50% Zr_{.942}Y_{.058}O_{1.971} + | | Fluorite + | Fluorite + |
| | 50% LaAl₁₁O₁₈ | | (m) ZrO₂ + | (m) ZrO₂ + |
| | | | Magnetoplumbite | Magnetoplumbite |
| 2 | 50% Zr_{.942}Y_{.058}O_{1.971} + | | Fluorite + | Fluorite + |
| | 50% NdAl₁₁O₁₈ | | Corundum | Corundum |
| 3 | 50% Zr_{.942}Y_{.058}O_{1.971} + | | Fluorite + | Fluorite + |
| | 50% LaMgAl₁₁O₁₉ | | (m) ZrO₂ + | (m) ZrO₂ + |
| | | | Magnetoplumbite | Magnetoplumbite |
| 4 | 50% Zr_{.74}Nd_{.26}O_{1.87} + | | Fluorite + | Fluorite + |
| | 50% NdAl₁₁O₁₈ | | Corundum + | Magnetoplumbite |
| | | | NdAlO₃ | |
| | | | (Perovskite) | |
| 5 | 50% Zr_{.70}Nd_{.30}O_{1.85} + | | Fluorite + | Fluorite + |
| | 50% NdAl₁₁O₁₈ | | Corundum + | NdAlO₃ |
| | | | NdAlO₃ | (Perovskite) + |
| | | | (Perovskite) | Magnetoplumbite |
| 6 | 50% Zr_{.67}Nd_{.33}O_{1.835} + | | Fluorite + | Fluorite + |
| | 50% NdAl₁₁O₁₈ | | Corundum + | NdAlO₃ |
| | | | NdAlO₃ | (Perovskite) + |
| | | | (Perovskite) | Magnetoplumbite |
| 7 | 50% Zr_{.67}Y_{.167}Ta_{.167}O₂ + | | (t) ZrO₂ + | (t) ZrO2 + |
| | 50% NdAl₁₁O₁₈ | | Pyrochlore + | Corundum |
| | | | Corundum | |
| 8 | 50% Zr_{.67}Y_{.167}Ta_{.167}O₂ + | | (t) ZrO₂ + | (t) ZrO₂ + |
| | 50% LaMgAl₁₁O₁₈ | | Magnetoplumbite | (m) ZrO₂+ |
| | | | | Magnetoplumbite |
| 9 | 50% Zr_{.82}Y_{.09}Ta_{.09}O₂ + | (t) ZrO₂ + | Fluorite + | |
| | 50% NdAl₁₁O₁₈ | (m) ZrO₂ + | Corundum + | |
| | | Corundum | NdAlO₃ | |
| | | | (Perovskite) | |
| 10 | 50% Zr_{.82}Y_{.09}Ta_{.09}O₂ + | | Fluorite + | Fluorite + |
| | 50% LaMgAl₁₁O₁₉ | | (m) ZrO₂ + | (m) ZrO₂ + |
| | | | Magnetoplumbite | Magnetoplumbite |
| 11 | 50% Zr_{.67}Y_{.167}Nb_{.167}O₂ + | | Fluorite + | Fluorite + |
| | 50% NdAl₁₁O₁₈ | | Pyrochlore + | Corundum + |
| | | | Magnetoplumbite | NdAlO₃ |
| | | | | (Perovskite) |
| 12 | 50% Zr_{.67}Y_{.167}Nb_{.167}O₂ + | | Fluorite + | Fluorite + |
| | 50% LaMgAl₁₁O₁₈ | | Magnetoplumbite | (m) ZrO₂ + |
| | | | | Magnetoplumbite |
| 13 | 50% Zr_{.82}Y_{.09}Nb_{.09}O₂ + | | Fluorite + | Fluorite + |
| | 50% NdAl₁₁O₁₈ | | (m) ZrO₂ + | (m) ZrO₂ + |
| | | | Corundum | Corundum |
| 14 | 50% Zr_{.82}Y_{.09}Nb_{.09}O₂ + | | Fluorite + | Fluorite + |
| | 50% LaMgAl₁₁O₁₉ | | (m) ZrO₂ + | (m) ZrO₂ + |
| | | | Magnetoplumbite | Magnetoplumbite |

It may be observed that magnetoplum bite is found to be present in compositions 1, 3-6, 8, 10-12, and 14 for at least at one of 1450° C., 1500° C., and 1600° C. Furthermore, tetragonal zirconia is found to be present in compositions 7-9 for at least at one of 1450° C., 1500° C., and 1600° C. Thus, compositions 1, and 3-12 are expected to exhibit improved toughness due to at least one of crack bridging, transformation toughening, and ferroelastic toughening. Furthermore, of these compositions, composition 8 is observed to possess both magnetoplumbite and tetragonal zirconia. Thus, it is expected that composition 8 would possess even higher toughness due to both crack bridging and at least one of transformation toughening and ferroelastic toughening.

### Examples of SOFCs Having Enhanced Toughness Components:

In some embodiments, an anode of an SOFC can include a multiphase ceramic having a first phase formed from a cubic and/or tetragonally stabilized metal oxide such as doped cerium oxide, and a second phase formed from a magnetoplumbite-based material, such as an aluminate, that is chemically compatible with the first phase. The first phase (e.g., fluorite phase) of the doped cerium oxide typically has a low fracture toughness. As described herein, addition of the magnetoplumbite-based aluminate to the first phase material can significantly enhance the fracture toughness of the multiphase ceramic.

Examples related to such enhancement of fracture toughness are described herein. In some embodiments, as applied to SOFC, the cubic and/or tetragonally stabilized metal oxide can be doped cerium oxide, with a stabilizing element being, for example, gadolinium (Gd). For example, the doped cerium oxide can be Gd_{0.2}Ce_{0.8}Oₓ. It will be understood that other relative concentration of Gd can also be utilized. It will also be understood that other stabilizing elements, including some or all of the examples described herein, can also be utilized.

In some embodiments, the addition of the second phase to the doped cerium oxide can result in deterioration of electrochemical performance of the resulting material. In such situations, the resulting material can be utilized as an anodic structural component, thus eliminating or reducing the need to use materials such as zirconia for structural support.

### Examples of Aluminates:

By way of non-limiting examples, LaAl₁₁O₁₈, CeAl₁₁O₁₈, PrAl₁₁O₁₈, NdAl₁₁O₁₈ and LaMgAl₁₁O₁₉ (each with a magnetoplumbite structure) were added to Gd_{0.2}Ce_{0.8}Oₓ in specific weight percentages, and heated at approximately 1450 degree C. for approximately 24 hours. Table 2 indicates the nature of the resulting phases.

TABLE 2

| Additive | 20 weight % | 40 weight % | 60 weight % | 80 weight % |
|---|---|---|---|---|
| LaAl₁₁O₁₈ | Fluorite + | Fluorite + | Fluorite + | Fluorite + |
| | Perovskite | Perovskite + | Perovskite + | Perovskite + |
| | | Magnetoplumbite | Magnetoplumbite | Magnetoplumbite |
| CeAl₁₁O₁₈ | Fluorite + | Fluorite + | Fluorite + | Fluorite + |
| | Corundum | Corundum | Corundum | Corundum |
| PrAl₁₁O₁₈ | Fluorite + | Fluorite + | Fluorite + | Fluorite + |
| | Perovskite + | Perovskite + | Perovskite + | Perovskite + |
| | Magnetoplumbite | Magnetoplumbite | Magnetoplumbite | Magnetoplumbite |
| NdAl₁₁O₁₈ | Fluorite + | Fluorite + | Fluorite + | Fluorite + |
| | Perovskite | Perovskite + | Perovskite + | Perovskite + |
| | | Corundum | Corundum + | Corundum + |
| | | | Magnetoplumbite | Magnetoplumbite |
| LaMgAl₁₁O₁₉ | Fluorite + | Fluorite + | Fluorite + | Fluorite + |
| | Perovskite + | Perovskite + | Perovskite + | Perovskite + |
| | Lanthanum | Lanthanum | Magnetoplumbite | Magnetoplumbite |
| | Magnesium | Magnesium | | |
| | Aluminate | Aluminate | | |

The phases listed in Table 2 were determined by x-ray diffraction of pulverized samples. Based on such x-ray diffraction results, it is noted that materials showing desirable properties for anodic structural application can include, for example, LaAl₁₁O₁₈, PrAl₁₁O₁₈ and NdAl₁₁O₁₈.

### Examples of Anode Configurations:

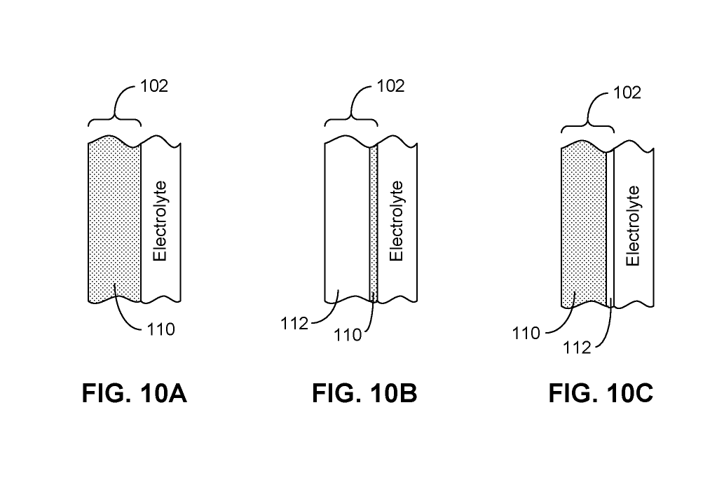

FIGS. 10A-10C show that in some embodiments, a multiphase ceramic material described herein, including one or more materials listed in Table 2, can be utilized to form some or all of an anode 102 for an SOFC. In the examples of FIGS. 10A-10C, the multiphase ceramic material is indicated as 110.

In the example of FIG. 10A, substantially all of the anode 102 can be formed from a multiphase ceramic material 110 having one or more features as described herein. In such a configuration, the multiphase ceramic layer 110 can provide both electrochemical functionality and enhancement in fracture toughness.

In the example of FIG. 10B, an anodic functional layer of the anode 102 can be formed from a multiphase ceramic material 110 having one or more features as described herein. Such an anode can further include a substrate layer 112. In such a configuration, the multiphase ceramic layer 110 can provide electrochemical functionality, as well as some enhancement in fracture toughness.

In the example of FIG. 10C, a multiphase ceramic material 110 having one or more features as described herein can be utilized as a substrate for the anode 102. Such an anode can further include a separate anodic functional layer 112. In such a configuration, the multiphase ceramic layer 110 can provide electrochemical functionality and enhancement in fracture toughness.

### Examples Related to Fabrication of Anodes:

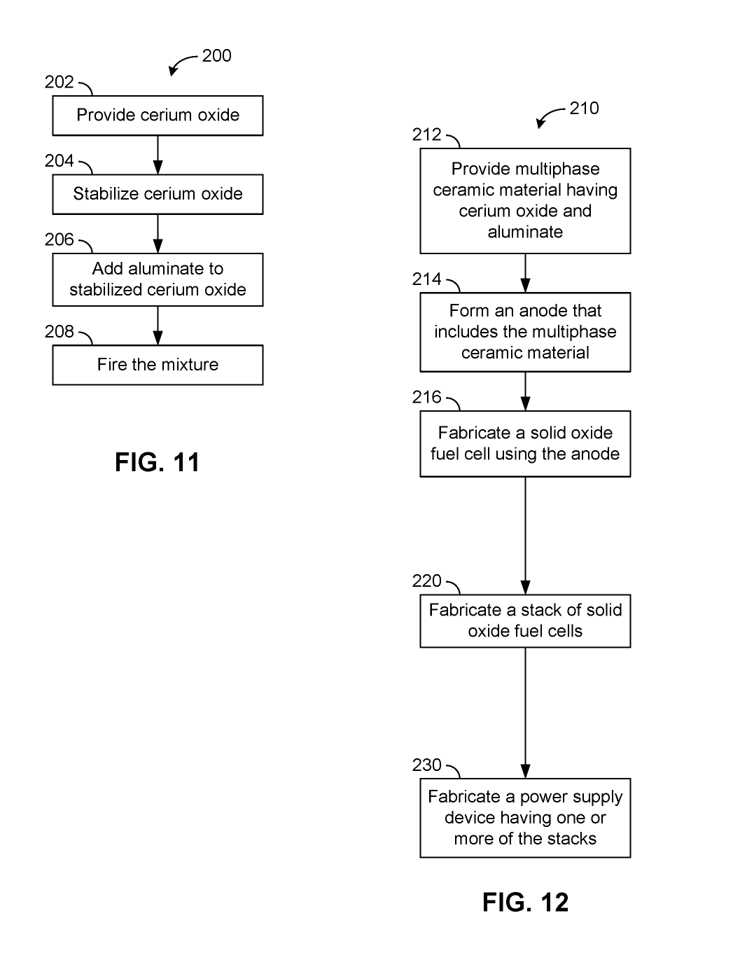

FIG. 11 shows a process 200 that can be implemented to fabricate a multiphase ceramic material having one or more features as described herein. In block 202, cerium oxide can be provided. In block 204, cerium oxide can be doped with a stabilizing element (e.g., Gd) to yield a stabilized form of cerium oxide. In block 206, an aluminate having a magnetoplum bite structure can be added to the stabilized form of cerium oxide. In block 208, the resulting mixture can be fired to yield a multiphase ceramic material having one or more features as described herein.

FIG. 12 shows a process 210 that can be implemented to fabricate an SOFC. In block 212, a multiphase ceramic material having one or more features as described herein can be formed or provided. In block 214, an anode can be formed from the multiphase ceramic material. In some embodiments, the anode can be formed by the firing process (block 208) of FIG. 11. In some embodiments, the anode can be formed by further processing a fired multiphase ceramic material. In block 216, an SOFC can be fabricated with the foregoing anode.

In some embodiments, a plurality of SOFCs can be connected so as to yield a desired output power. Such an arrangement of SOFCs can include, for example, a stack. Such a stack can be formed in block 220. It will be understood that such a step may or may not be a continuation of the foregoing process for fabrication of an SOFC.

In some embodiments, one or more of SOFC stacks can be utilized to fabricate a power supply. Such a power supply can be formed in block 230. It will be understood that such a step may or may not be a continuation of the foregoing process for fabrication of a stack.

### Examples of Products Based on SOFC:

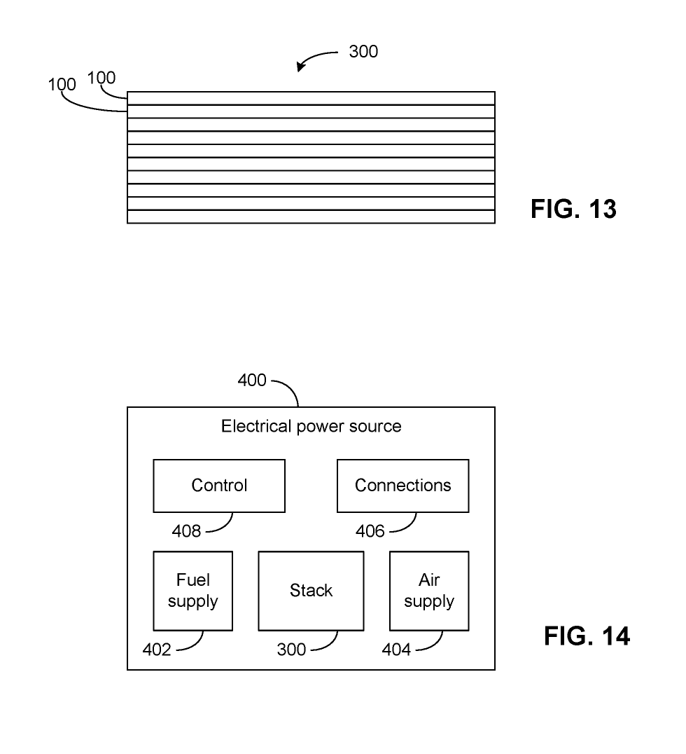

As described in reference to FIG. 12, a plurality of SOFCs can be arranged in a stack. In FIG. 13, such a stack is depicted as 300 having a number of SOFCs 100. In some embodiments, such SOFCs can be electrically connected in series to obtain a desired power output from the stack 300.

As also described in reference to FIG. 12, one or more stacks can be implemented as a power source. FIG. 14 shows an example of an electrical power source 400 having a stack 300 having one or more features as described herein. The power source 400 can further include a fuel supply component 402 and an air supply component 404 to facilitate operation of SOFCs of the stack 300. The power source 400 can further include electrical connections 406 configured to allow electricity to be delivered out of the electrical power source 400. The power source 400 can further include a control component 408 configured to provide and/or facilitate control of one or more functionalities associated with the power source 400.

Examples Related to Alternate and/or Additional Designs:

Various examples are described herein in the context of a multiphase ceramic having stabilized cerium oxide, and how such material can be utilized in an anode of an SOFC. However, it will be understood that one or more features of the present disclosure can also be implemented for such an SOFC application utilizing other stabilized metal oxides such as zirconium oxide.

It will also be understood that any of the foregoing stabilized metal oxides, individually or in any combination, can be utilized to form some or all of an electrochemically active component of an SOFC. Such an electrochemically active component can include an anode, an electrolyte, or any combination thereof. As described herein, the foregoing multiphase ceramic having stabilized metal oxide can yield desirable mechanical properties such as enhanced fracture toughness for the electrochemically active component of the SOFC.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While some embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

1. A solid oxide fuel cell (SOFC) comprising an electrochemically active component that includes a multiphase ceramic having a stabilized metal oxide material and a magnetoplumbite-based material, the multiphase ceramic configured to provide enhanced fracture toughness for the electrochemically active component.

2. The SOFC of claim 1 wherein the stabilized metal oxide material includes at least one of stabilized cerium oxide and stabilized zirconium oxide.

3. The SOFC of claim 2 wherein the electrochemically active component includes an anode.

4. The SOFC of claim 3 wherein the anode includes the stabilized cerium oxide.

5. The SOFC of claim 2 wherein the electrochemically active component includes an electrolyte.

6. The SOFC of claim 5 wherein the electrolyte includes the stabilized zirconium oxide.

7. The SOFC of claim 1 wherein the stabilized metal oxide material is configured to provide a first phase of the multiphase ceramic.

8. The SOFC of claim 7 wherein the magnetoplumbite-based material is configured to provide a second phase of the multiphase ceramic that is chemically compatible with the first phase.

9. The SOFC of claim 8 wherein the stabilized metal oxide material includes stabilized cerium oxide.

10. The SOFC of claim 9 wherein the magnetoplumbite-based material includes an aluminate.

11. The SOFC of claim 10 wherein the stabilized metal oxide material includes a stabilizing element selected from the group consisting of Mg, Ca, La, In, Sc, Ce, Pr, Nd, Sm, Gd, Dy, Tb, Eu, Ho, Er, Yb, Y, Lu, Tm, Ga, Fe, Mn, Cr, and Bi.

12. The SOFC of claim 11 wherein the stabilized cerium oxide includes Gd_{0.2}Ce_{0.8}Oₓ.

13. The SOFC of claim 10 wherein the aluminate includes one or more of LaAl₁₁O₁₈, PrAl₁₁O₁₈ and NdAl₁₁O₁₈.

14. The SOFC of claim 13 wherein the aluminate includes LaAl₁₁O₁₈.

15. The SOFC of claim 14 wherein LaAl₁₁O₁₈ forms 40% or more in specific weight percentage relative to the stabilized cerium oxide.

16. The SOFC of claim 13 wherein the aluminate includes PrAl₁₁O₁₈.

17. The SOFC of claim 16 wherein PrAl₁₁O₁₈ forms 20% or more in specific weight percentage relative to the stabilized cerium oxide.

18. The SOFC of claim 13 wherein the aluminate includes NdAl₁₁O₁₈.

19. The SOFC of claim 18 wherein NdAl₁₁O₁₈ forms 60% or more in specific weight percentage relative to the stabilized cerium oxide.

20. (canceled)

21. (canceled)

22. (canceled)

23. (canceled)

24. (canceled)

25. (canceled)

26. (canceled)

27. (canceled)

28. A power source device comprising one or more solid oxide fuel cells (SOFCs) configured to generate electrical power when operating, each SOFC including an electrochemically active component having a multiphase ceramic with a stabilized metal oxide material and a magnetoplumbite-based material, the multiphase ceramic configured to provide enhanced fracture toughness for the electrochemically active component.

29. (canceled)

30. (canceled)

31. A method for fabricating an electrochemically active component for a solid oxide fuel cell (SOFC), the method comprising:
providing a stabilized metal oxide material;
combining a magnetoplumbite-based material with the stabilized metal oxide to form a mixture; and
firing the mixture to form a multiphase ceramic capable of being formed into the electrochemically active component.

32. (canceled)

33. (canceled)

34. (canceled)

35. (canceled)

36. (canceled)

37. (canceled)

38. (canceled)

39. (canceled)

40. (canceled)

41. (canceled)
